(19) United States
(12) Patent Application Publication
(10) Pub. No.: US 2025/0053755 A1
(43) Pub. Date: Feb. 13, 2025

(54) Polyglot GPT Engine: Generative Pre-Trained Transformer Based Multilingual Chatbot

(71) Applicants: Dissanayake Gunasekera, Houston, TX (US); Yasantha Rajakarunanayake, San Ramon, CA (US); Joshua Gunasekera, Houston, TX (US)

(72) Inventors: Dissanayake Gunasekera, Houston, TX (US); Yasantha Rajakarunanayake, San Ramon, CA (US); Joshua Gunasekera, Houston, TX (US)

(21) Appl. No.: 18/793,943

(22) Filed: Aug. 5, 2024

Related U.S. Application Data
(63) Continuation of application No. 63/518,561, filed on Aug. 10, 2023.

(51) Int. Cl. G06F 40/58; G06F 40/205; G06F 40/30

(52) U.S. Cl. CPC G06F 40/58; G06F 40/205; G06F 40/30

(57) ABSTRACT

This invention introduces a robust multilingual chatbot system that amalgamates a semantic translation engine with a potent generative pre-trained transformer. This system enables seamless knowledge dissemination across language barriers, thereby empowering users to engage in natural language conversations in their preferred language.

### DETAILED DESCRIPTION OF DRAWINGS

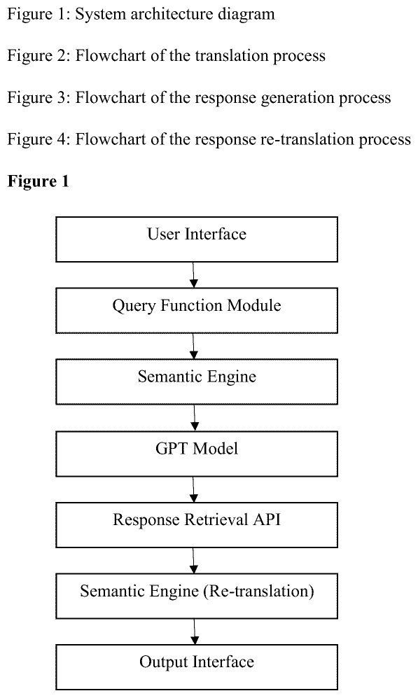

FIG. 1: System architecture diagram showing the interaction between the user interface, query function module, semantic engine, GPT model, response retrieval API, response translation module, and output interface.

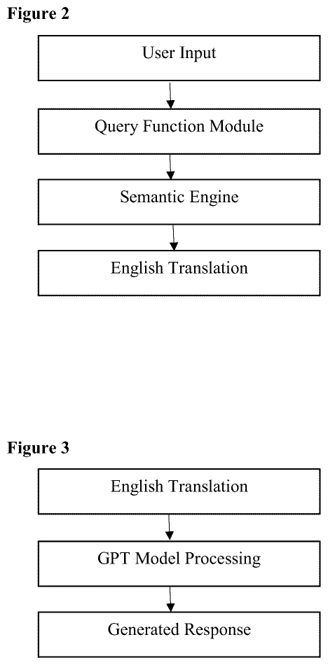

FIG. 2: Flowchart illustrating the translation process from user input to English.

FIG. 3: Flowchart illustrating the response generation process using the GPT model.

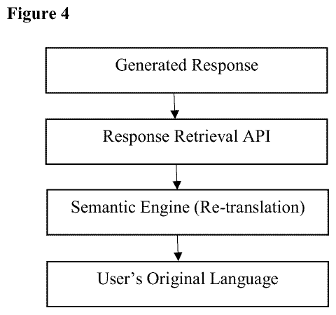

FIG. 4: Flowchart illustrating the re-translation process from English to the user's original language and delivery of the response.

### FIELD OF THE DISCLOSURE

The invention relates to the field of Artificial Intelligence, particularly natural language understanding and multilingual communication.

### BACKGROUND

Generative Pre-Trained Transformer (GPT) is designed to comprehend and generate human-like text, effectively interpreting large volumes of textual data. This capability allows it to address a diverse range of queries, prompts, and conversational topics. The system can be employed in machine translation tasks, translating text from one language to another. This underlying technology is suited for chatbots and virtual assistants, facilitating natural language interactions with users across various applications such as customer support and personal assistance. With its training based on a vast amount of data from the internet, GPT can assist users in exploring new subjects, acquiring general knowledge, or finding references for further research.

### BRIEF SUMMARY OF THE INVENTION

This invention introduces a multilingual chatbot system that integrates a semantic translation engine with a Generative Pre-Trained Transformer (GPT) model. The system is capable of receiving user input in various languages, translating the input to English, generating a response in English using the GPT model, and then translating the response back into the user's original language. This process enables effective and natural communication across language barriers.

### BRIEF DESCRIPTION OF DRAWINGS

The invention comprises five key stages illustrated in the accompanying drawings:

Receiving user questions in any language.

Translating the non-English text into English using a Semantic Engine and API.

Processing the translated text via the Generative Pre-Trained Transformer (GPT) model to generate a response.

Retrieving the generated response via an API.

Re-translating the response from English to the user's original language using the Semantic Engine.

### DETAILED DESCRIPTION

The invention is a multilingual chatbot system comprising:

a) A query function that receives user questions in any language;

b) A semantic engine using an API to translate non-English text into English;

c) A Generative Pre-Trained Transformer (GPT) model that processes the translated text to generate a response;

d) An API to retrieve the generated response;

e) A semantic engine to re-translate the response from English to the original language of the user.

Overall, this multilingual chatbot system employs sophisticated machine learning and natural language processing technologies to facilitate a seamless and user-friendly conversation interface for a diverse, global user base. It integrates translation capabilities with advanced language models like GPT to understand, generate, and deliver responses across languages. This technology has significant potential for customer service, social media automation, and any application that requires interactive, language-independent, text-based communication.

### SYSTEM ARCHITECTURE

The system architecture of the multilingual chatbot is illustrated in FIG. 1. The architecture includes the following components:

User Interface (UI): The front-end interface where users input their questions and receive responses. The UI supports multiple languages.

Query Function Module: Receives and processes user input in various languages.

Semantic Engine: Utilizes an API to translate non-English input into English. This engine employs machine learning algorithms for accurate semantic translation.

Generative Pre-Trained Transformer (GPT) Model: A backend processing module that generates responses based on the translated English input.

Response Retrieval API: Fetches the generated response from the GPT model.

Response Translation Module: Uses the Semantic Engine to re-translate the English response back into the user's original language.

Output Interface: Delivers the translated response back to the user in their original language.

### FUNCTIONAL FLOW

The functional flow of the multilingual chatbot system is depicted in FIGS. 2, 3, and 4. The flow involves the following steps:

Step 1: Receiving User Input: The user inputs a question or query in their preferred language via the User Interface.

Step 2: Translating Input: The input text is sent to the Semantic Engine, where it is translated into English.

Step 3: Generating Response: The translated text is processed by the GPT model to generate a relevant response.

Step 4: Retrieving Response: The generated response is retrieved via the Response Retrieval API.

Step 5: Translating Response: The English response is sent back to the Semantic Engine, where it is re-translated into the user's original language.

Step 6: Delivering Response: The translated response is delivered back to the user through the Output Interface.

### Existing Solutions

Natural Language Understanding: GPT excels at understanding and generating human-like text, handling complex language patterns, answering questions, summarizing documents, and providing contextually relevant responses.

Pre-training on Large Corpora: GPT's training on vast amounts of publicly available text data allows it to capture a broad spectrum of knowledge and linguistic nuances.

Transfer Learning: GPT leverages transfer learning by pre-training on large-scale datasets and then fine-tuning on specific downstream tasks.

### Existing Drawbacks

Lack of Factual Accuracy: GPT may generate plausible but incorrect answers due to its training patterns. It lacks a built-in mechanism to verify the accuracy of its responses.

Sensitivity to Input Phrasing: Small alterations in input phrasing can yield significantly different outputs, leading to potential inconsistencies.

Biases in Training Data: GPT may inadvertently produce biased outputs if trained on biased data, potentially reinforcing societal biases or stereotypes.

### Proposed Enhancements

Cultural and Linguistic Diversity: Training the language model to gather and disseminate knowledge and understanding of diverse cultures and nations.

Increased Language Support: Inclusion of more languages for global adaptability.

Informal Language Handling: Better handling of informal language and regional dialects.

Optimization: Optimizing response time and implementing feedback systems for continuous improvement.

1. A multilingual chatbot system utilizing a GPT model based on the Generative Pre-Trained Transformer architecture.

2. The semantic engine in the multilingual chatbot system employs a translation engine for sentence parsing and interpretive services.

3. The multilingual chatbot system requires valid Application Programmer Interfaces (APIs) for the GPT model and semantic transformation.

4. The system of claim 1, wherein the query function module is configured to handle user inputs in a plurality of languages.

5. The system of claim 1, wherein the semantic engine includes a machine learning algorithm to improve translation accuracy over time.

6. The system of claim 1, wherein the GPT model is fine-tuned to understand and generate responses based on diverse cultural contexts.

7. The system of claim 1, wherein the response retrieval API ensures secure and efficient communication between the GPT model and other system components.

8. The system of claim 1, wherein the response translation module uses context-aware translation techniques to maintain the meaning and intent of the original response.

9. The system of claim 1, further comprising a feedback mechanism to collect user feedback and improve system performance.

10. The system of claim 1, wherein the output interface is designed to support various forms of text-based communication, including chat applications, social media platforms, and customer support interfaces.
CONCLUSION
In summary, the Polyglot GPT Engine represents a significant advancement in the field of artificial intelligence and multilingual communication. By seamlessly integrating a semantic translation engine with a generative pre-trained transformer (GPT) model, this invention addresses and overcomes key limitations of existing technologies. It offers a robust solution for natural language understanding and generation across diverse languages and dialects, ensuring accurate and contextually appropriate responses.
The system architecture, detailed in the drawings, highlights the efficient workflow from receiving user inputs in various languages to generating and delivering responses in the users' original languages. Key components such as the query function module, semantic engine, GPT model, and response retrieval API work in tandem to provide a seamless user experience. This integration ensures that the system is capable of handling complex language patterns and delivering high-quality translations and responses.
Moreover, the invention's capability to enhance cultural and linguistic diversity, increase language support, handle informal language and regional dialects, and optimize response times demonstrates its adaptability and potential for widespread application. The feedback mechanisms incorporated within the system ensure continuous improvement and user satisfaction.
The claims outlined in this application encompass the novel aspects of this multilingual chatbot system, including the use of a GPT model for text generation, the implementation of semantic engines for translation and re-translation, and the secure and efficient communication facilitated by APIs. These claims ensure comprehensive coverage of the unique features and benefits offered by the Polyglot GPT Engine.
In conclusion, the Polyglot GPT Engine sets a new standard for multilingual chatbots, providing a versatile, user-friendly, and technologically advanced solution for global communication needs. This invention holds significant promise for various applications, including customer service, social media automation, and personal assistance, making it an invaluable tool in the era of globalization and digital communication.
